(19) United States
(12) Patent Application Publication
(10) Pub. No.: US 2021/0311582 A1
(43) Pub. Date: Oct. 7, 2021

(54) TOUCH PANELS WITH STATIC AND DYNAMIC FORCE SENSING CAPABILITIES

(71) Applicant: SHARP KABUSHIKI KAISHA, Sakai City (JP)

(72) Inventors: JEAN MUGIRANEZA, Sakai City (JP); ANDREW KAY, Oxford (GB)

(21) Appl. No.: 16/842,638

(22) Filed: Apr. 7, 2020

(51) Int. Cl. G06F 3/041; G06F 3/044

(52) U.S. Cl. CPC G06F 3/0414; G06F 2203/04105; G06F 3/044

(57) ABSTRACT

A touch panel includes at least one capacitive touch sensing electrode, at least one first force sensing electrode, a second force sensing electrode, an elastomeric layer between the at least one capacitive touch sensing electrode and the at least one first force sensing electrode, and a piezo-electric layer between the least one first force sensing electrode and the second force sensing electrode, where the at least one capacitive touch sensing electrode, the at least one first force sensing electrode, and the second force sensing electrode are coupled to a sensing integrated circuit capable of sensing a projected capacitance touch, a piezo-electric force, and an elastomeric force simultaneously.

### FIELD

The present disclosure generally relates to touch panels, and in particular to touch panels with static and dynamic force sensing capabilities.

### BACKGROUND

User interactions through traditional keyboard, mouse, and joystick with physical buttons and levers will be replaced by sensors integrated in multi-touch sensor panels and configured by software to be shown sensed on the display panel. Touch panels will be integrated with display panels for control and display content simultaneously, for example, on smartphones, notebook/laptop PCs, game consoles, industrial and automotive controls.

In recent years, attention has been drawn to sensors that can detect both static and dynamic forces on a touch panel. Replacing traditional physical hardware, such as mouse and keyboard, presents challenges. For example, users may be accustomed to rest their fingers on a keyboard without necessarily pressing. Projected capacitance touch (as is standard technology on all smart phones) sensors alone can't reliably distinguish which finger or fingers are pressing as opposed to just resting. Virtual buttons can be pressed quickly (as in typing) which cannot be sensed well by an elastomeric force sensor. Virtual buttons can be pressed or held down (as in scrolling, when using control or shift keys, or controlling a game), but cannot be sensed well by a piezo-electric force sensor. In other examples, some applications require the detection of a finger above the display (hovering in the air) such as help displays (“tool tips”), which cannot be sensed by a force sensor, only by a projected capacitance touch sensor. In addition, projected capacitance may be better than force sensing for gestures such as flicking and sliding and for very light touches such as painting.

Thus, there is a need to achieve novel kinds of interaction with electronic devices through touch panels with static and dynamic force sensing capabilities.

### CITATION LIST

U.S. Pat. No. 10,310,659 (Cambridge Touch Technologies Ltd., Published on Jun. 4, 2019).
U.S. Pat. No. 8,698,769 (Sharp Kabushiki Kaisha, Published on Apr. 15, 2014).

### SUMMARY

The present disclosure is directed to touch panels with static and dynamic force sensing capabilities.

In a first aspect of the present disclosure, a touch panel includes at least one capacitive touch sensing electrode, at least one first force sensing electrode, a second force sensing electrode, an elastomeric layer between the at least one capacitive touch sensing electrode and the at least one first force sensing electrode, and a piezo-electric layer between the least one first force sensing electrode and the second force sensing electrode.

In an implementation of the first aspect, the touch panel also includes at least one shared sensing electrode between the elastomeric layer and the at least one capacitive touch sensing electrode.

In another implementation of the first aspect, the at least one shared sensing electrode extends along a first direction, and the at least one capacitive touch sensing electrode extends along a second direction intersecting the first direction.

In yet another implementation of the first aspect, the touch panel also includes an insulating layer between the at least one shared sensing electrode and the at least one capacitive touch sensing electrode.

In yet another implementation of the first aspect, the at least one shared sensing electrode is used as a shield electrode or a transmit electrode for force sensing.

In yet another implementation of the first aspect, a deformation of the elastomeric layer relates to a static force of pressing the touch panel, and a charge generated by the piezo-electric layer is related to a dynamic force on the touch panel.

In yet another implementation of the first aspect, the touch panel also includes a display stack, where the elastomeric layer and the piezo-electric layer are disposed on one side of the display stack.

In yet another implementation of the first aspect, the display stack includes an organic electroluminescent layer or a liquid crystal layer.

In yet another implementation of the first aspect, the touch panel also includes a display stack, where the elastomeric layer and the piezo-electric layer are disposed on opposite sides of the display stack.

In yet another implementation of the first aspect, the display stack includes an organic electroluminescent layer.

In yet another implementation of the first aspect, the at least one capacitive touch sensing electrode, the at least one first force sensing electrode, and the second force sensing electrode are coupled to a sensing integrated circuit capable of sensing a projected capacitance touch, a piezo-electric force, and an elastomeric force simultaneously.

In yet another implementation of the first aspect, the at least one capacitive touch sensing electrode, the at least one first force sensing electrode, the second force sensing electrode, and the at least one shared sensing electrode are coupled to a sensing integrated circuit capable of sensing a projected capacitance touch, a piezo-electric force, and an elastomeric force simultaneously.

In a second aspect of the present disclosure, a touch panel includes a capacitive touch sensing electrode layer having at least one capacitive touch sensing electrode, a first force sensing electrode layer having at least one first force sensing electrode, a second force sensing electrode layer having a second force sensing electrode, an elastomeric layer between the capacitive touch sensing electrode layer and the first force sensing electrode layer, a piezo-electric layer between the first force sensing electrode layer and the second force sensing electrode layer; a shared sensing electrode layer having at least one shared sensing electrode between the elastomeric layer and the capacitive touch sensing electrode layer, where the at least one capacitive touch sensing electrode, the at least one first force sensing electrode, the second force sensing electrode, and the at least one shared sensing electrode are coupled to a sensing integrated circuit capable of sensing a projected capacitance touch, a piezo-electric force, and an elastomeric force simultaneously.

In an implementation of the second aspect, the at least one shared sensing electrode extends along a first direction, and the at least one capacitive touch sensing electrode extends along a second direction intersecting the first direction.

In another implementation of the second aspect, the touch panel also includes an insulating layer between the shared sensing electrode layer and the capacitive touch sensing electrode layer.

In yet another implementation of the second aspect, the at least one shared sensing electrode is used as a shield electrode or a transmit electrode for force sensing.

In yet another implementation of the second aspect, a deformation of the elastomeric layer relates to a static force of pressing the touch panel, and a charge generated by the piezo-electric layer is related to a dynamic force on the touch panel.

In yet another implementation of the second aspect, the touch panel also includes a display stack, where the elastomeric layer and the piezo-electric layer are disposed on one side of the display stack.

In yet another implementation of the second aspect, the display stack includes an organic electroluminescent layer or a liquid crystal layer.

In yet another implementation of the second aspect, the touch panel also includes a display stack including an organic electroluminescent layer, where the elastomeric layer and the piezo-electric layer are disposed on opposite sides of the display stack.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a cross-sectional view illustrating an integrated sensor for allowing capacitive touch, piezo-electric force and elastomeric force sensing, according to an example implementation of the present disclosure.

FIG. 2 is a schematic circuit diagram of a sensing circuit coupled to an integrated sensor, according to an example implementation of the present disclosure.

FIG. 3 is a schematic circuit diagram of a sensing circuit coupled to sensing elements of an integrated sensor, according to an example implementation of the present disclosure.

FIG. 4 is a schematic circuit diagram of a sensing circuit coupled to sensing elements of an integrated sensor, according to an example implementation of the present disclosure.

FIGS. 5A and 5B illustrate example output responses for a press event, according to example implementations of the present disclosure.

FIG. 6A is a cross-sectional view illustrating an integrated sensor for allowing capacitive touch, piezo-electric force and elastomeric force sensing, according to an example implementation of the present disclosure.

FIG. 6B is a top plan view illustrating the integrated sensor in FIG. 6A for allowing capacitive touch, piezo-electric force and elastomeric force sensing, according to an example implementation of the present disclosure.

FIG. 7 is a schematic circuit diagram of a sensing circuit coupled to sensing elements of an integrated sensor, according to an example implementation of the present disclosure.

FIG. 8A is a schematic circuit diagram of sensing elements of an integrated sensor, according to an example implementation of the present disclosure.

FIG. 8B is a schematic circuit diagram of sensing elements of an integrated sensor, according to an example implementation of the present disclosure.

FIG. 9A is a diagram illustrating a method for decoding sensed signals from a sensing IC, according to an example implementation of the present disclosure.

FIG. 9B is a diagram illustrating another method for decoding sensed signals from a sensing IC, according to an example implementation of the present disclosure.

FIG. 9C is a diagram illustrating yet another method for decoding sensed signals from a sensing IC, according to an example implementation of the present disclosure.

FIG. 10 is a cross-sectional view illustrating configuration of a display panel having an integrated sensor, in accordance with an example implementation of the present disclosure.

FIG. 11A is a cross-sectional view illustrating a configuration of an organic electroluminescent (EL) display panel having integrated sensor, according to an example implementation of the present disclosure.

FIG. 11B is a cross-sectional view illustrating a configuration of another organic EL display panel having integrated sensor, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standards, and the like are set forth for providing an understanding of the described technology. In other examples, detailed description of well-known methods, technologies, systems, architectures, and the like are omitted so as not to obscure the description with unnecessary details.

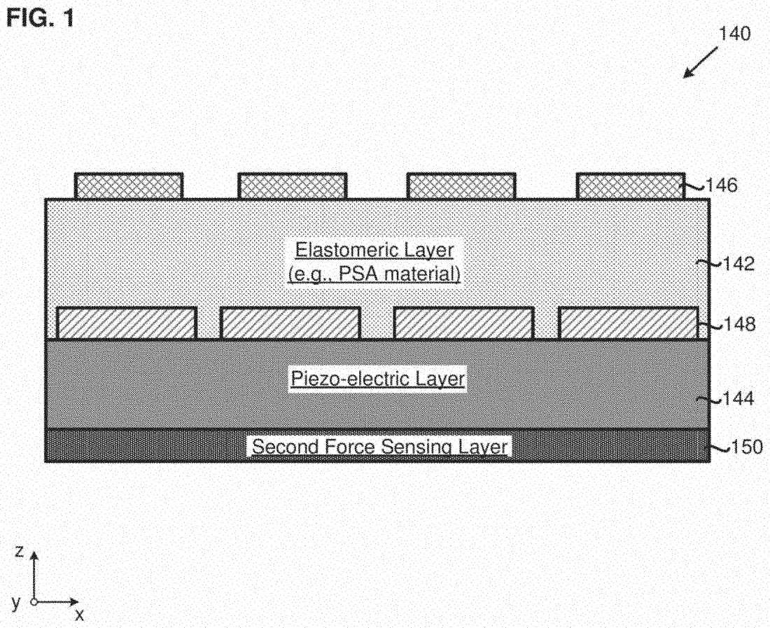

FIG. 1 is a cross-sectional view illustrating an integrated sensor for allowing capacitive touch, piezo-electric force and elastomeric force sensing, according to an example implementation of the present disclosure. In FIG. 1, an example integrated sensor 140 includes a layered structure comprising a plurality of layers for sensing touch and pressure. In the integrated sensor 140, each layer extends perpendicularly to the thickness direction (e.g., in the x-y plane perpendicular to the z-direction). The integrated sensor 140 includes at least one elastomeric layer 142 (e.g., having a low Young's modulus elastomeric material) and at least one piezo-electric layer 144 having (e.g., having a piezo-electric material). The integrated sensor 140 also includes several layers of sensing electrodes. For example, the sensing electrode layers include at least one touch sensing electrode layer 146, a first force sensing electrode layer 148, and a second force sensing electrode layer 150. Each of the touch sensing electrode layer 146, the first force sensing electrode layer 148, and the second force sensing electrode layer 150 may include one or more electrodes therein.

In the present implementation, the elastomeric layer 142 may have a low Young's modulus adhesive material (e.g., having Young's Modulus below 0.1 MPa). In one implementation, the elastomeric layer 142 may include pressure sensitive adhesive (PSA) material. The elastomeric layer 142 is disposed between the touch sensing electrode layer 146 and the first force sensing electrode layer 148. The deformation of the elastomeric layer 142 relates to the static force of pressing the integrated sensor 140.

The piezo-electric layer 144 is disposed on the other side of the first force sensing electrode layer 148, between the first force sensing electrode layer 148 and the second force sensing electrode layer 150. The piezo-electric layer 144 may include piezo-electric materials such as a piezo-electric polymer (e.g., polyvinylidene fluoride (PVDF)) or a piezo-electric ceramic (e.g., lead zirconate titanate (PZT)). The piezo-electric layer 144 is configured to generate charge in response to dynamic forces on the integrated sensor 140.

The touch sensing electrode layer 146 is disposed on the elastomeric layer 142. The touch sensing electrode layer 146 may be used as a shield electrode, a transmit electrode for touch sensing, or a transmit electrode for force sensing. The touch sensing electrode layer 146 may prevent the presence of a finger from affecting the force measurement.

The touch sensing electrode layer 146, the first force sensing electrode layer 148, and the second force sensing electrode layer 150 may each include one or more electrodes made of indium tin oxide (ITO) or indium zinc oxide (IZO), for example. The touch sensing electrode layer 146, the first force sensing electrode layer 148, and the second force sensing electrode layer 150 may be coupled to a sensing integrated circuit (IC) (not explicitly shown in FIG. 1) to sense a projected capacitance touch, a piezo-electric force, and an elastomeric force simultaneously.

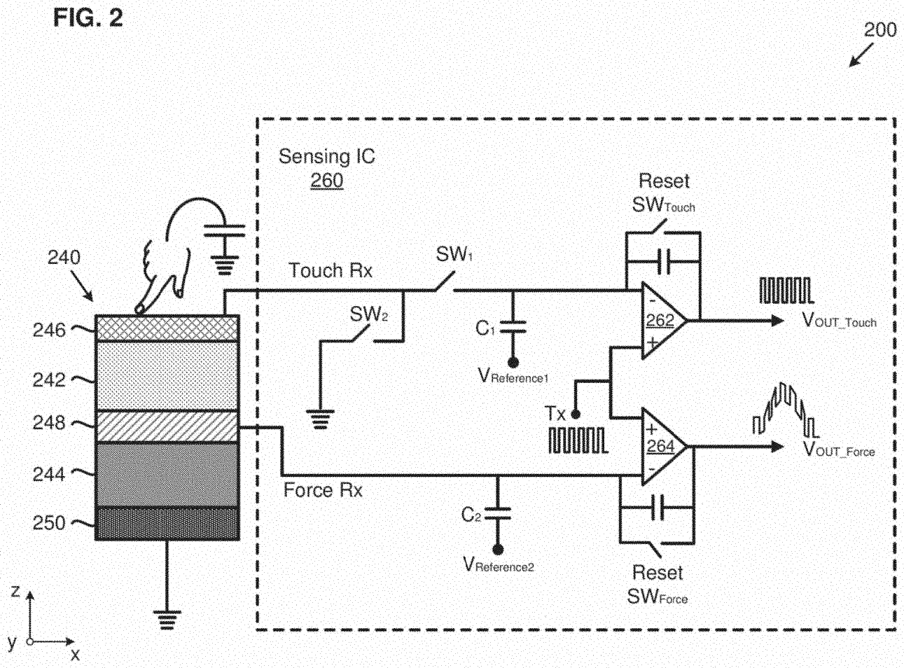

FIG. 2 is a schematic circuit diagram 200 of a sensing circuit coupled to an integrated sensor, according to an example implementation of the present disclosure. In the circuit diagram 200, an example integrated sensor 240 is coupled to a sensing IC 260.

In FIG. 2, the integrated sensor 240 includes an elastomeric layer 242, a piezo-electric layer 244, a touch sensing electrode layer 246, a first force sensing electrode layer 248, and a second force sensing electrode layer 250, which may substantially correspond to the elastomeric layer 142, the piezo-electric layer 144, the touch sensing electrode layer 146, the first force sensing electrode layer 148, and the second force sensing electrode layer 150, respectively, in FIG. 1. Thus, the details of these layers in the integrated sensor 240 are omitted for brevity.

In FIG. 2, the touch sensing electrode layer 246 is electrically coupled to the negative terminal of an integrator 262 (e.g., a current integrator) through switch SW1. The positive terminal of the integrator 262 is coupled to a stimulus signal (e.g., Tx). For example, in self-capacitance mode, a controlled stimulus signal can be applied to the integrator 262 as well as another integrator 264 (e.g., a current integrator).

The first force sensing electrode layer 248 is electrically coupled to the negative terminal of the integrator 264, while the positive terminal of the integrator 264 is coupled to the stimulus signal (Tx). The second force sensing electrode layer 250 is electrically coupled to the ground.

When switch SW1 is closed and switch SW2 is open, in response to a touch applied to the integrated sensor 240, the integrator 262 may compare the stimulus signal with the input from the touch sensing electrode layer 246, and output a touch related signal (e.g., V_{OUT_Touch}). Also, in response to the touch applied to the integrated sensor 240, the integrator 264 may compare the stimulus signal with the input from the force sensing electrode layer 248, and output a force related signal (e.g., V_{OUT_Force}).

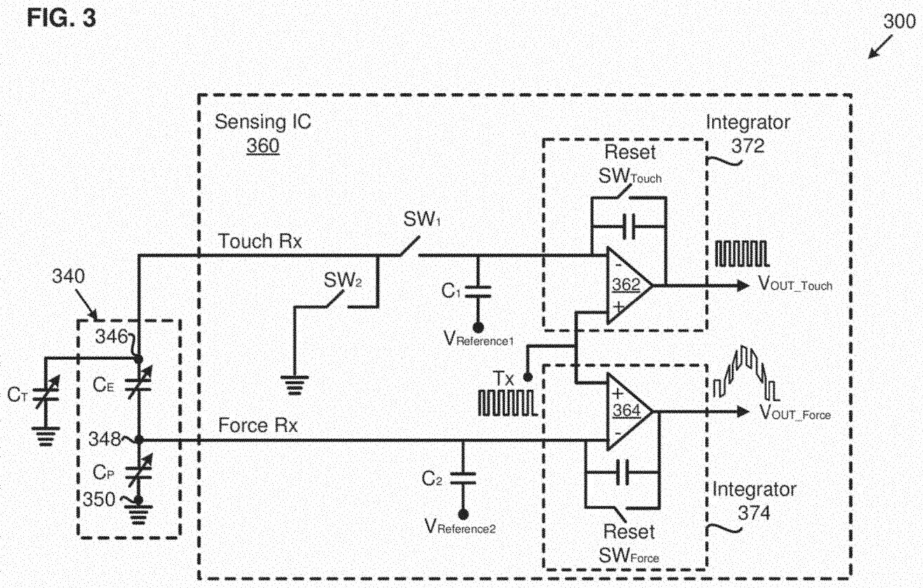

FIG. 3 is a schematic circuit diagram 300 of a sensing circuit coupled to sensing elements of an integrated sensor, according to an example implementation of the present disclosure. In the circuit diagram 300, an example integrated sensor 340 is coupled to a sensing IC 360.

As shown in FIG. 3, the integrated sensor 340 includes a capacitor C_{T} formed between a touch sensing electrode 346 and ground for touch sensing. For example, the capacitance of the capacitor C_{T} may be based on a user touching or hovering a finger over the integrated sensor 340. The integrated sensor 340 also includes a capacitor C_{E}, for example, having an elastomeric material (e.g., the elastomeric layer 142 in FIG. 1) formed between the touch sensing electrode 346 and a first force sensing electrode 348 for elastomeric force sensing. The integrated sensor 340 further includes a capacitor C_{P}, for example, having a piezo-electric material (e.g., the piezo-electric layer 144 in FIG. 1) formed between the first force sensing electrode 348 and a second force sensing electrode 350 for piezo-electric force sensing.

The touch sensing electrode 346 of the capacitor C_{E} is coupled to the negative terminal of a comparator 362 of an integrator 372 (e.g., a current integrator) through switch SW1. The comparator 362 receives a Touch Rx from the touch sensing electrode 346 at its negative terminal, and a stimulus signal Tx at its positive terminal. The output of the integrator 372 (e.g., V_{OUT_Touch}) is coupled to an A/D convertor not explicitly shown in FIG. 3.

The first force sensing electrode 348 of the capacitor C_{P} is coupled to the negative terminal of a comparator 364 of another integrator 374 (e.g., a current integrator). The comparator 364 receives a Force Rx from the first force sensing electrode 348 at its negative terminal, and the stimulus signal Tx at its positive terminal. The output of the integrator 374 (e.g., V_{OUT_Force}) is coupled to another A/D convertor not explicitly shown in FIG. 3.

In the present implementation, the integrated sensor 340 is able to sense static and dynamic forces based on self-capacitance circuit sensing. To reset the sensing IC 360, reset switch, Reset SW_{Touch}, and reset switch, Reset SW_{Force}, are closed, and the stimulus signal (Tx) is set to low. When the integrated sensor 340 is in operation (e.g., sampling), Reset SW_{Touch} and Reset SW_{Force} are both open, and the stimulus signal Tx is set to high. The output V_{OUT_Force} is proportional to C_{E}+C_{P}.

The output V_{OUT_Force} is proportional to the capacitance of the capacitor C_{P}. The capacitors C₁ and C₂ model parasitic effects of the rest of the system. The capacitor C₂ can be augmented with additional capacitor if necessary to match the capacitance of the capacitor C_{P}. The capacitor C_{T} models the capacitance to ground which is modified by the presence of, for example, a finger. The capacitors C_{E} and C_{P} are the elastomeric and piezo-electric force responses, respectively.

Baseline measurements are obtained by sampling when no input is present, as a calibration step and by continuous update process (e.g., to account for gradual environment changes such as temperature). These values can be subtracted (by using software) from running measurements to take account of capacitors C₁ and C₂, and the inactive state of the sensors, returning in each case a capacitance change directly related to the input signal.

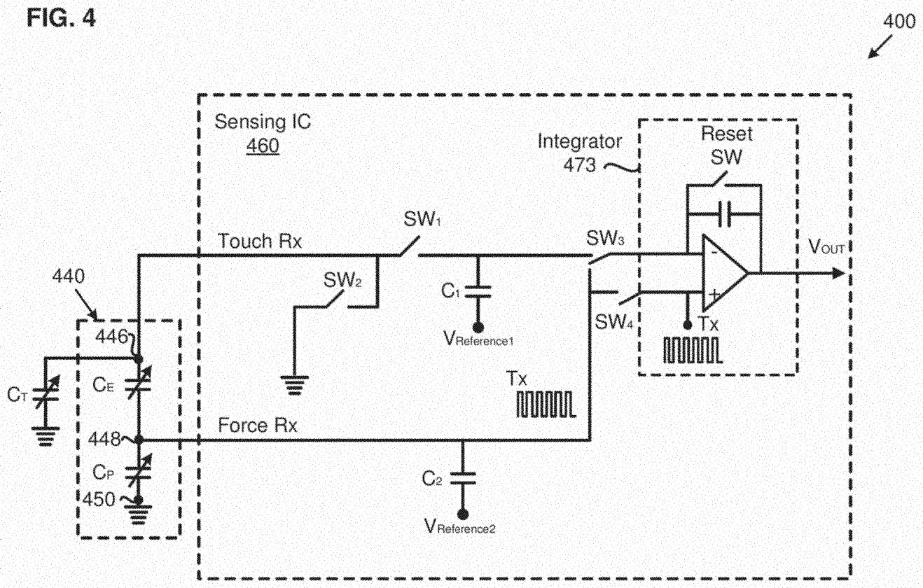

FIG. 4 is a schematic circuit diagram 400 of a sensing circuit coupled to sensing elements of an integrated sensor structure, according to an example implementation of the present disclosure. In the circuit diagram 400, an example integrated sensor 440 is coupled to a sensing IC 460.

In the present implementation, the integrated sensor 440 having a touch sensing electrode 446, a capacitor C_{E}, a capacitor C_{T}, a first force sensing electrode 448, a capacitor C_{P}, and a second force sensing electrode 450 may correspond to the integrated sensor 340 having the respective features in FIG. 3. Thus, the details of the integrated sensor 440 are omitted for brevity.

In the sensing IC 460, only one integrator 473 (e.g., a current integrator) is used for both touch and force sensing, thus time-multiplexing is used to switch between touch and force sensing through the operations of switches SW1, SW2, SW3, and SW4.

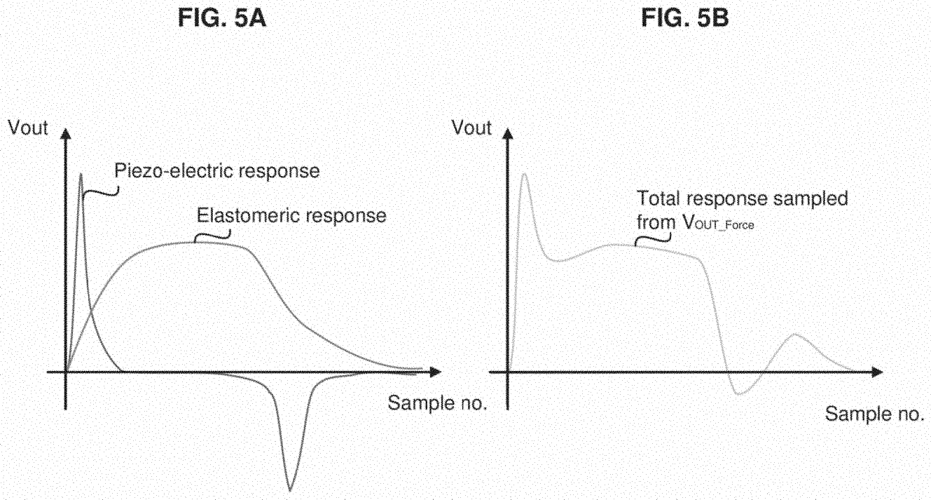

FIGS. 5A and 5B illustrate example output responses for a press event, according to example implementations of the present disclosure. Output signals (e.g., V_{OUT_Touch} and V_{OUT_Force} in FIG. 3) may be read by converting the signals both the V_{OUT_Touch} and V_{OUT_Force} to digital values using one or more A/D converters.

When an external object is present near the electrodes, such as a finger (which provides a conductive path to ground at or around the driving frequencies), the measured capacitance at V_{OUT_Touch} may decrease (as is normal with a projected capacitance sensor).

When the external object presses on the cover film of a display/touch panel, as the pressure changes:
(a) the elastomeric force sensor's capacitance increases with pressure (static sensing), as shown by the elastomeric response curve in FIG. 5A.
(b) the piezo-electric force sensor generates a charge, as shown by the positive spike on the elastomeric response curve in FIG. 5A.

Because the charge in response to piezo-electric force is removed by the sensing circuit, the resulting measurement decays over time unless the force changes (dynamic sensing). The decay rate depends on the input impedance of the detection circuit, which must be designed/tuned for good performance.

As shown in FIG. 5B, these signals (e.g., the piezo-electric response and elastomeric response in FIG. 5A) are inherently summed by the circuit and the sampled output on V_{OUT_Force} is the sum of both, as shown in the total response curve.

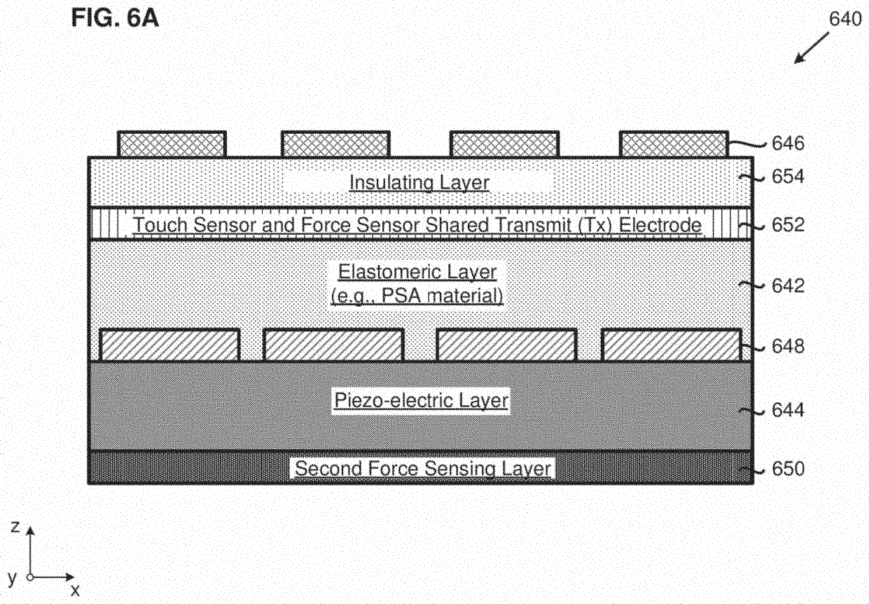

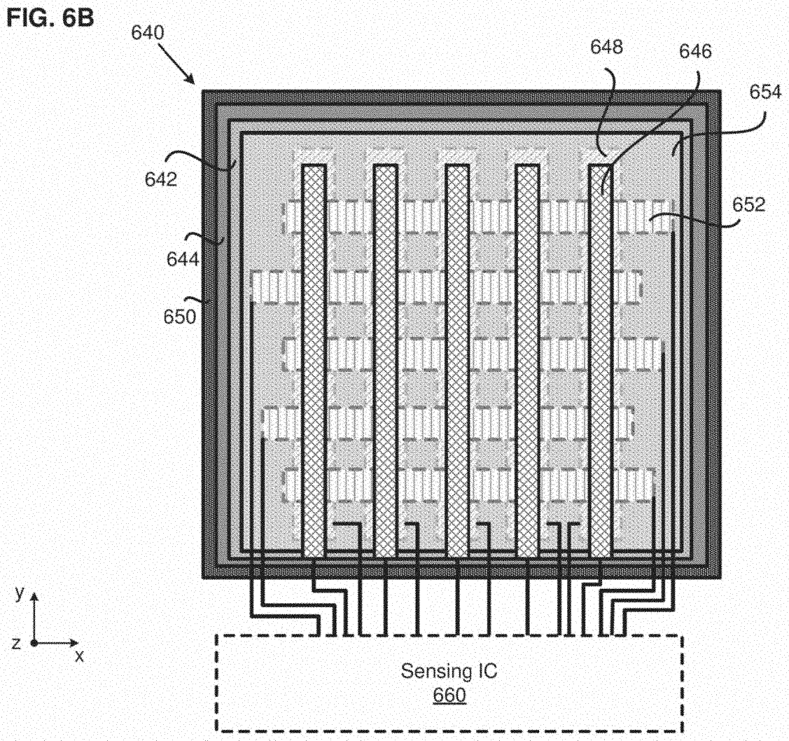

FIG. 6A is a cross-sectional view illustrating an integrated sensor structure for allowing capacitive touch, piezo-electric force and elastomeric force sensing, according to an example implementation of the present disclosure.

In FIG. 6A, an example integrated sensor 640 includes a layered structure comprising a plurality of layers for sensing touch and pressure. In the integrated sensor 640, each layer extends perpendicularly to the thickness direction (e.g., in the x-y plane perpendicular to the z-direction). The integrated sensor 640 includes at least one elastomeric layer 642 (e.g., having a low Young's modulus elastomeric material), at least one piezo-electric layer 644 having (e.g., having a piezo-electric material), and an insulating layer 654. The integrated sensor 640 also includes several layers of sensing electrodes. For example, the sensing electrode layers include at least one touch sensing electrode layer 646, a first force sensing electrode layer 648, a second force sensing electrode layer 650, a touch sensor and force sensor shared transmit electrode layer 652. Each of the touch sensing electrode layer 646, the first force sensing electrode layer 648, the second force sensing electrode layer 650, the touch sensor and force sensor shared transmit electrode layer 652 may include one or more electrodes therein.

In the present implementation, the elastomeric layer 642 may have a low Young's modulus adhesive material (e.g., having Young's Modulus below 0.1 MPa). In one implementation, the elastomeric layer 642 may include PSA material. The elastomeric layer 642 is disposed between the touch sensor and force sensor shared transmit electrode layer 652 and the first force sensing electrode layer 648. The deformation of the elastomeric layer 642 relates to the static force of pressing the integrated sensor 640.

The piezo-electric layer 644 is disposed on the other side of the first force sensing electrode layer 648, and between the first force sensing electrode layer 648 and the second force sensing electrode layer 650. The piezo-electric layer 644 may include piezo-electric materials such as a piezo-electric polymer (e.g., PVDF) or a piezo-electric ceramic (e.g., PZT). The piezo-electric layer 644 is configured to generate charge in response to dynamic forces on the integrated sensor 640.

The insulating layer 654 is disposed on the other side of the touch sensor and force sensor shared transmit electrode layer 652, and between the touch sensor and force sensor shared transmit electrode layer 652 and the touch sensing electrode layer 646.

The touch sensing electrode layer 646 is disposed on the insulating layer 654. The touch sensing electrode layer 646 may be used as a shield electrode. The touch sensing electrode layer 646 may prevent the presence of a finger from affecting the force measurement. The touch sensor and force sensor shared transmit electrode layer 652 may also be used as a shield electrode. In addition, the touch sensor and force sensor shared transmit electrode layer 652 may also be used as a transmit electrode for touch sensing and a transmit electrode for force sensing.

The touch sensing electrode layer 646, the first force sensing electrode layer 648, the second force sensing electrode layer 650, and the touch sensor and force sensor shared transmit electrode layer 652 may each include one or more electrodes made of indium tin oxide (ITO) or indium zinc oxide (IZO), for example.

FIG. 6B is a top plan view illustrating the integrated sensor 640 in FIG. 6A for allowing capacitive touch, piezo-electric force and elastomeric force sensing, according to an example implementation of the present disclosure. It should be noted that certain layers (e.g., the insulating layer 654, the elastomeric layer 642, etc.) in FIG. 6B are rendered at least partially transparent for visual clarity.

As shown in FIG. 6B, electrodes in the touch sensing electrode layer 646 (e.g., Rx electrode for touch electrode) and the first force sensing electrode layer 648 extend along the y-direction, while electrodes in the touch sensor and force sensor shared transmit electrode layer 652 extend along the x-direction intersecting the y-direction. The electrodes in the touch sensing electrode layer 646, the first force sensing electrode layer 648, and the touch sensor and force sensor shared transmit electrode layer 652 are electrically coupled to their respective terminals in a sensing IC 660 for capacitive touch, piezo-electric force and elastomeric force sensing.

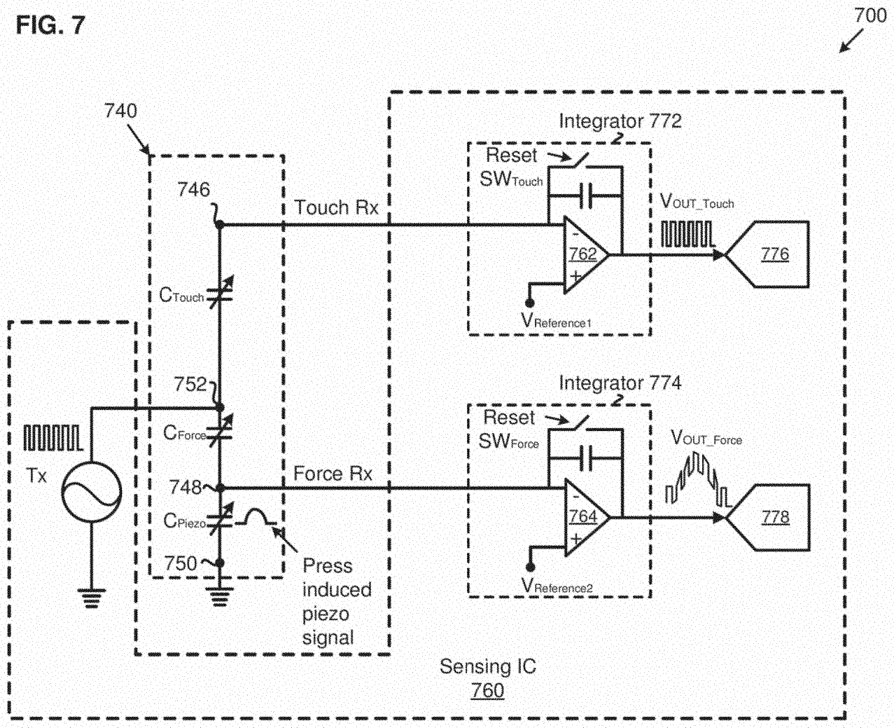

FIG. 7 is a schematic circuit diagram 700 of a sensing circuit coupled to sensing elements of an integrated sensor structure, according to an example implementation of the present disclosure. In the circuit diagram 700, an example integrated sensor 740 is coupled to a sensing IC 760.

In FIG. 7, the integrated sensor 740 includes a capacitor C_{Touch}, for example, having an insulating material (e.g., the insulating layer 654 in FIG. 6A) formed between a touch sensing electrode 746 and a touch sensor and force sensor shared transmit electrode 752 for touch sensing. The integrated sensor 740 also includes a capacitor C_{Force}, for example, having an elastomeric material (e.g., the elastomeric layer 642 in FIG. 6A) formed between the touch sensor and force sensor shared transmit electrode 752 and a first force sensing electrode 748 for elastomeric force sensing. The integrated sensor 740 further includes a capacitor C_{Piezo}, for example, having a piezo-electric material (e.g., the piezo-electric layer 644 in FIG. 6A) formed between the first force sensing electrode 748 and a second force sensing electrode 750 for piezo-electric force sensing.

To reset the sensing IC 760, reset switch Reset SW_{Touch} and reset switch Reset SW_{Force} are closed, and a stimulus signal Tx is set to low. When the integrated sensor 740 is in operation, Reset SW_{Touch} and Rest SW_{Force} are both open, and the stimulus signal Tx is provided to the touch sensor and force sensor shared transmit electrode 752, which is shared by the capacitor C_{Touch} and the capacitor C_{Force}.

The touch sensing electrode 746 of the capacitor C_{Touch} is coupled to the negative terminal of a comparator 762 of an integrator 772 (e.g., a current integrator). The comparator 762 receives a Touch Rx from the touch sensing electrode 746 at its negative terminal, and a V_{Reference1} at its positive terminal. The output (e.g., V_{OUT_Touch}) of the integrator 772 is coupled to an A/D convertor (ADC) 776 before further processing.

The touch sensor and force sensor shared transmit electrode 752 of the capacitor C_{Force} is coupled to the stimulus signal Tx. The first force sensing electrode 748 of the capacitor C_{Force} is coupled to the negative terminal of a comparator 764 of an integrator 774 (e.g., a current integrator). The comparator 764 receives a Force Rx from the first force sensing electrode 748 at its negative terminal, and a V_{Reference2} at its positive terminal. The output (e.g., V_{OUT_Force}) of the integrator 774 is coupled to an ADC 778 before further processing.

In the present implementation, with the touch sensor and force sensor shared transmit electrode 752, the integrated sensor 740 is able to sense static and dynamic forces using charge integration through the mutual capacitance. For example, capacitance can be measured between a transmit electrode (e.g., the touch sensor and force sensor shared transmit electrode layer 652) and a touch RX electrode (e.g., the touch sensing electrode layer 646). As a finger approaches the intersection of the two electrodes, it changes (e.g., reduces) this capacitance (e.g., the finger forms a third conductor electrically between the Tx and Rx electrodes). By choosing among the different Tx and Rx electrodes, each part of the sensor can be addressed, and a spatial map of finger presence can be efficiently built with a relatively number of electrodes (e.g., in comparison to self-capacitance sensing with reference to FIGS. 1-4).

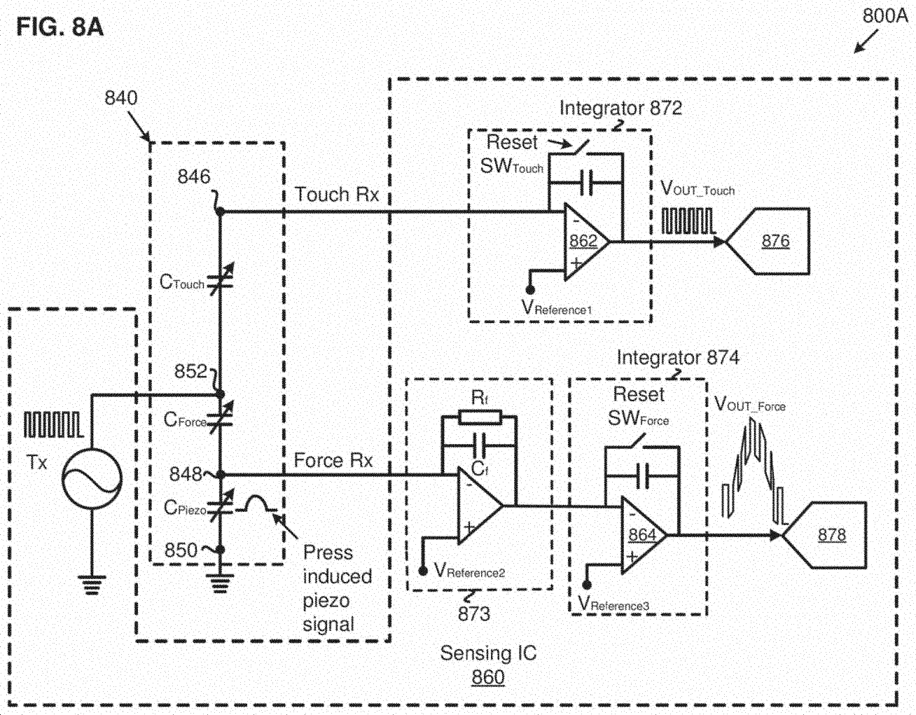

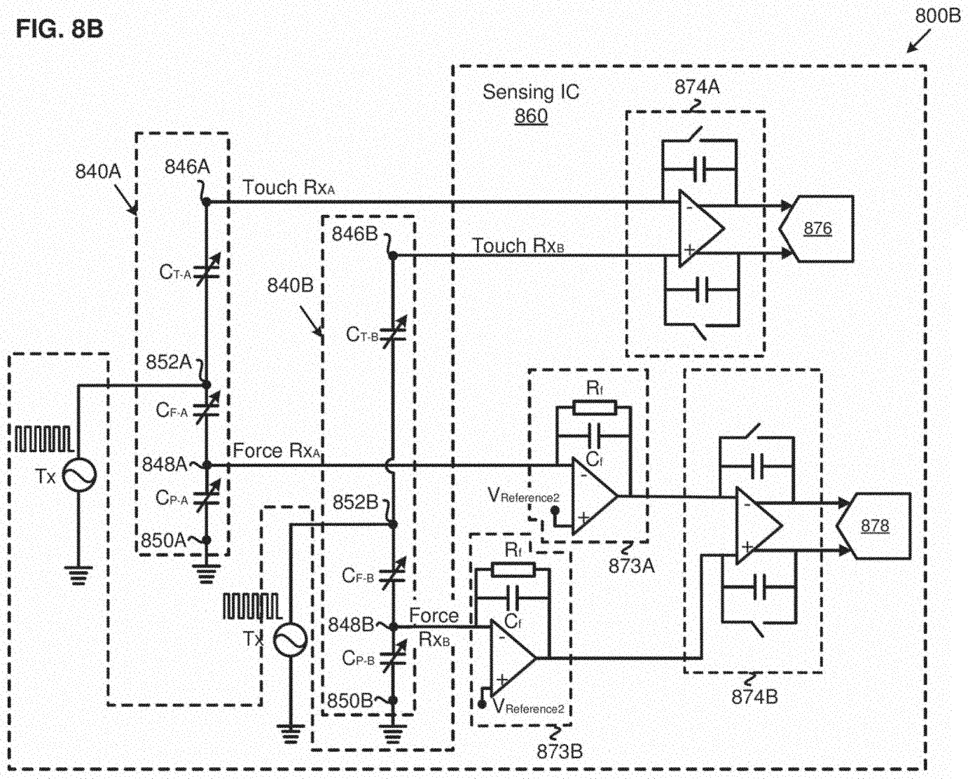

FIG. 8A is a schematic circuit diagram 800A of sensing elements of an integrated sensor structure, according to an example implementation of the present disclosure. In the circuit diagram 800A, an example integrated sensor 840 is coupled to a sensing IC 860.

In the present implementation, the integrated sensor 840 having a touch sensing electrode 846, a capacitor C_{Touch}, a touch sensor and force sensor shared transmit electrode 852, a capacitor C_{Force}, a first force sensing electrode 848, a capacitor C_{Piezo}, and a second force sensing electrode 850 may correspond to the respective features of the integrated sensor 740 in FIG. 7. Thus, the details of the integrated sensor 840 are omitted for brevity.

In the present implementation, the sensing IC 860 includes an integrator 872 (e.g., a current integrator having a comparator 862), an ADC 876, another integrator 874 (e.g., a current integrator having another comparator 864), and another ADC 878, which may correspond to the integrator 772, the ADC 776, the integrator 774, and the ADC 778, respectively, in FIG. 7. Thus, the details of these elements in the sensing IC 860 are omitted for brevity.

The sensing IC 860 operates substantially the same way as the sensing IC 760 in FIG. 7 does. Different from the sensing IC 760 in FIG. 7, in the sensing IC 860, a buffer/amplifier 873 is inserted between the first force sensing electrode 848 and the integrator 874 to amplify the force Rx signals. The buffer/amplifier 873 includes a feedback resistor R_{f} a feedback capacitor C_{f} coupled between the output and the negative terminal of the buffer/amplifier 873.

The feedback resistor R_{f} and feedback capacitor C_{f} are chosen to determine the response of the buffer/amplifier 873. For example, the feedback resistor R_{f} and feedback capacitor C_{f} are chosen so that frequency response (2π×R_{f}×C_{f}) determines how long the piezo charges are held, while the feedback capacitor C_{f} determines the gain. In other words, the feedback resistor R_{f} and feedback capacitor C_{f} are chosen to condition the piezo response so that the force-induced piezo signal lasts long enough to be properly detected by the integrator 874.

FIG. 8B is a schematic circuit diagram 800B of sensing elements of an integrated sensor structure, according to an example implementation of the present disclosure. In the circuit diagram 800B, example integrated sensors 840A and 840B are coupled to a sensing IC 860D for differential sensing.

In the present implementation, the integrated sensor 840A having a touch sensing electrode 846A, a capacitor C_{T-A}, a touch sensor and force sensor shared transmit electrode 852A, a capacitor C_{F-A}, a first force sensing electrode 848A, a capacitor C_{P-A}, and a second force sensing electrode 850A may correspond to the respective features of the integrated sensor 740 in FIG. 7. Thus, the details of the integrated sensor 840A are omitted for brevity.

Similarly, the integrated sensor 840B having a touch sensing electrode 846B, a capacitor C_{T-B}, a touch sensor and force sensor shared transmit electrode 852B, a capacitor C_{F-B}, a first force sensing electrode 848B, a capacitor C_{P-B}, and a second force sensing electrode 850B may also correspond to the respective features of the integrated sensor 740 in FIG. 7. Thus, the details of the integrated sensor 840B are omitted for brevity. In the present implementation, the integrated sensors 840A and 840B are integrated in the same touch panel.

In the present implementation, the touch sensing electrode 846A of the capacitor C_{T-A} of the integrated sensor 840A is coupled to the negative terminal of a differential amplifier 874A, while the touch sensing electrode 846B of the capacitor C_{T-B} of the integrated sensor 840B is coupled to the positive terminal of the differential amplifier 874A for differential sensing.

The differential amplifier 874A receives a Touch Rx_{A} from the integrated sensor 840A at its negative terminal, and a Touch Rx_{B} from the integrated sensor 840B at its positive terminal. The differential outputs of the differential amplifier 874A are provided to a differential ADC 876 before further processing.

In the present implementation, the first force sensing electrode 848A of the integrated sensor 840A is coupled to the negative terminal of another differential amplifier 874B through a buffer/amplifier 873A, while the first force sensing electrode 848B of the integrated sensor 840B is coupled to the positive terminal of the differential amplifier 874B through a buffer/amplifier 873B, for differential sensing. The buffer/amplifier 873A and buffer/amplifier 873B may each operate substantially similarly to the buffer/amplifier 873 in FIG. 8A. The details of the buffers/amplifiers 873A and 873B are omitted for brevity.

The differential amplifier 874B receives an amplified Force Rx_{A} from the integrated sensor 840A at its negative terminal, and an amplified Force Rx_{B} from the integrated sensor 840B at its positive terminal. The differential outputs of the differential amplifier 874B are provided to a differential ADC 878 before further processing.

The utilization of the differential amplifiers 874A and 874B can increase sensitivity of the integrated sensors. Also, the buffer/amplifier 873A and the buffer/amplifier 873B are beneficial to condition the piezo response so that the force-induced piezo signals from the integrated sensors 840A and 840B can last long enough to be properly detected by the differential amplifier 874B. It should be noted that, in one implementation, the buffer/amplifier 873A and buffer/amplifier 873B may be optional.

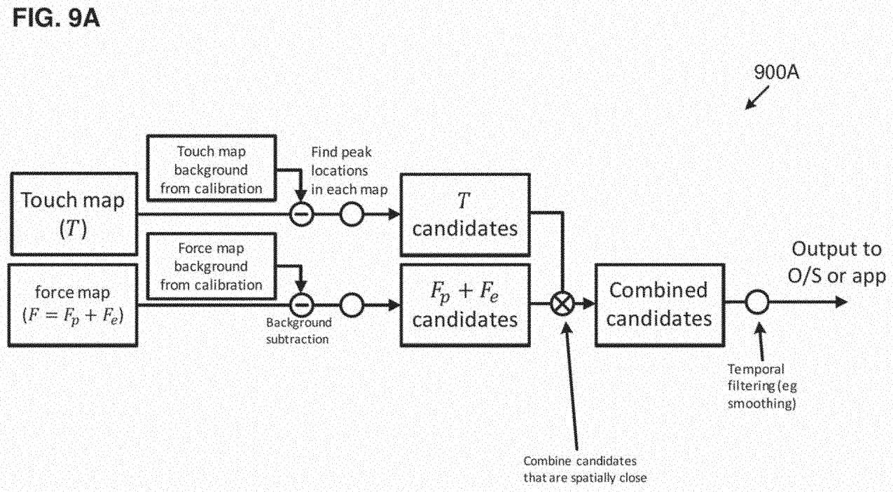

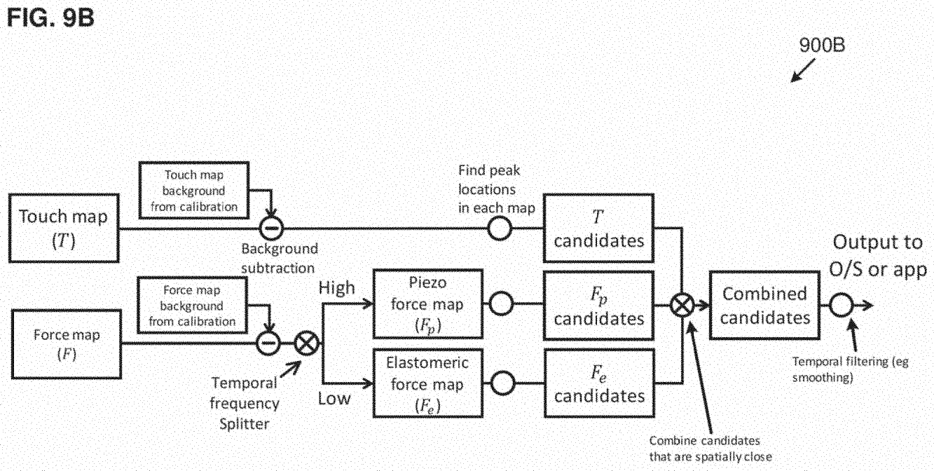

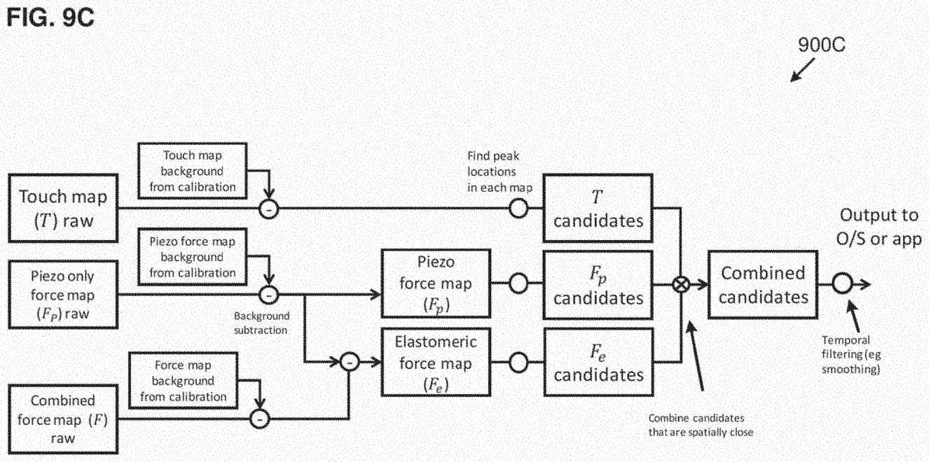

FIG. 9A is a diagram 900A illustrating a method for decoding sensed signals from a sensing IC, according to an example implementation of the present disclosure.

Hardware system naturally outputs a touch map and a force map for each moment in time (e.g., data comes from several overlaid electrode grids). The map is understood to be a spatial map relating position of each input signal to a position on the display. Algorithm analyses the maps and decodes the position and force components corresponding to each input probe. This probe information includes type (touch or force), strength of touch, information about area covered by touch, etc. Software may pass the information to the operating system (O/S) (if there is one) or to the running application for application-specific processing. For example, touch and force information sent to a drawing app to control position and width of stroke.

Additional kinds of output are possible. Filters to detect specific kinds of input are constructed in a way well known to persons skilled in the art (and not shown on the diagram 900A).

Many filtering steps are omitted here for simplicity, but are well known to makers of touch sensor algorithms: noise reduction, palm rejection, linearity correction, special filtering at sensor edges, etc.

Algorithm may include touch algorithms. Probe positions may correspond to peaks (or perhaps troughs, depending on sign of data). Depending on the probe, peaks may show up in one map or both. The combination step compares peak positions from the two maps and joins any detection candidates which are close together, combining the information about which kind of touch signal, peak strength, etc.

FIG. 9B is a diagram 900B illustrating another method for decoding sensed signals from a sensing IC, according to an example implementation of the present disclosure. In diagram 900B, a temporal frequency splitting filter is used, so that the force map can be separated into piezo- and elastomeric-force maps, and processed separately. For efficiency, it may be preferable to perform peak detection on the raw force map, only once, rather than twice. That is, peak detection before frequency filtering.

FIG. 9C is a diagram 900C illustrating yet another method for decoding sensed signals from a sensing IC, according to an example implementation of the present disclosure. In diagram 900C, when using self-capacitance mode, there is an extra option to capture 3 maps from the sensors: T, Fp+Fe as before, and also Fp alone.

It should be noted that, in all three algorithms, it is possible to achieve the same effect by performing similar actions in different orders. In diagrams 900A-900C, definite orders are shown for clarity. The algorithms are not limited by the definite orders shown in diagrams 900A-900C.

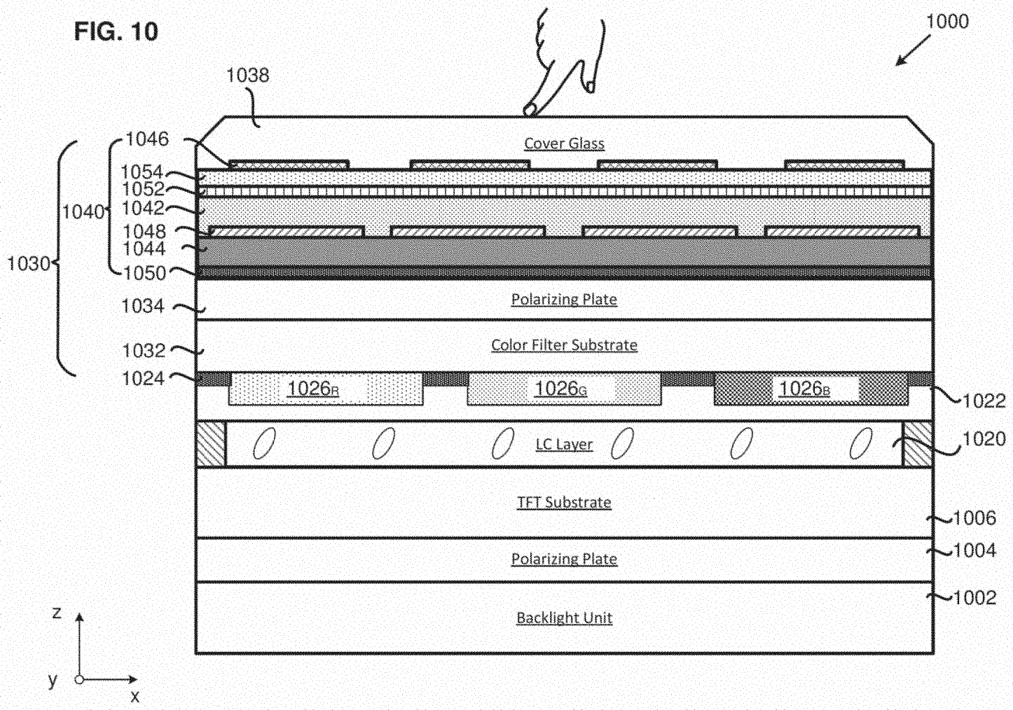

FIG. 10 is a cross-sectional view illustrating configuration of a display panel 1000 having an integrated sensor structure, in accordance with an example implementation of the present disclosure. In FIG. 10, a polarizing plate 1004 and a backlight unit 1002 are provided on a side of a TFT substrate 1006 that is opposite to a liquid crystal layer 1020 side.

The counter substrate 1030 includes a color filter (CF) substrate 1032, a polarizing plate 1034, an integrated sensor 1040 (e.g., a touch panel), and a cover glass 1038. The CF substrate 1032 includes a plurality of sub-pixels having color filters (e.g., color filters 1026R, 1026G, 1026B, etc.) and a light shielding layer (e.g., a black matrix) 1024, which are provided on the liquid crystal layer 1020 side of the CF substrate 1032.

The integrated sensor 1040 includes at least one elastomeric layer 1042 (e.g., having a low Young's modulus elastomeric material), at least one piezo-electric layer 1044 having (e.g., having a piezo-electric material), and an insulating layer 1054. The integrated sensor 1040 also includes several layers of sensing electrodes. For example, the sensing electrode layers include at least one touch sensing electrode layer 1046, a first force sensing electrode layer 1048, a second force sensing electrode layer 1050, a touch sensor and force sensor shared transmit electrode layer 1052. Each of the touch sensing electrode layer 1046, the first force sensing electrode layer 1048, the second force sensing electrode layer 1050, the touch sensor and force sensor shared transmit electrode layer 1052 may include one or more electrodes therein.

In the present implementation, the features in the integrated sensor 1040 are substantially the same as the respective features in the integrated sensor 640 described with reference to FIG. 6A above. Thus, the details of the integrated sensor 1040 are omitted for brevity.

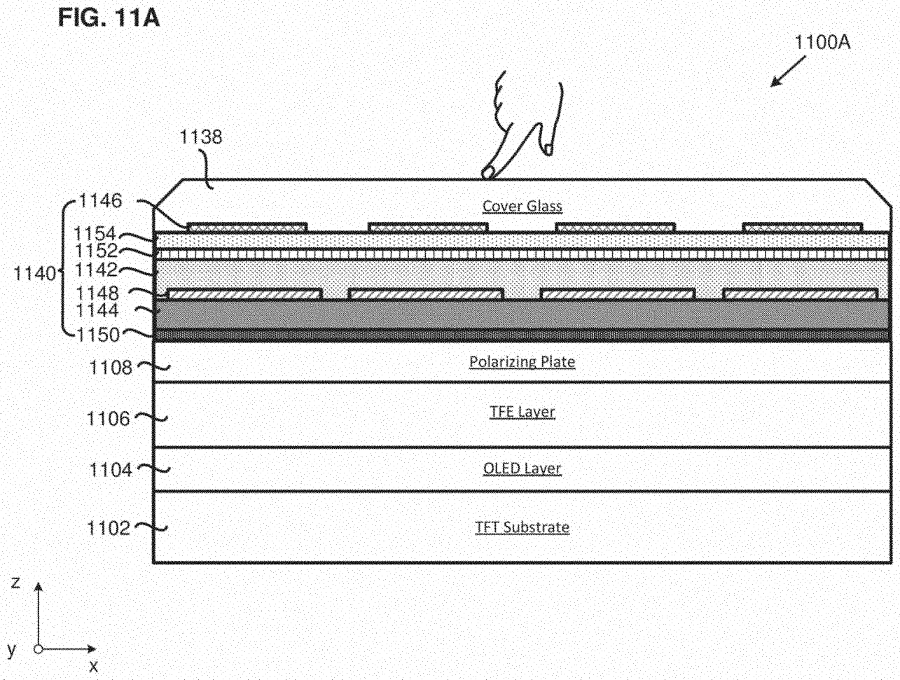

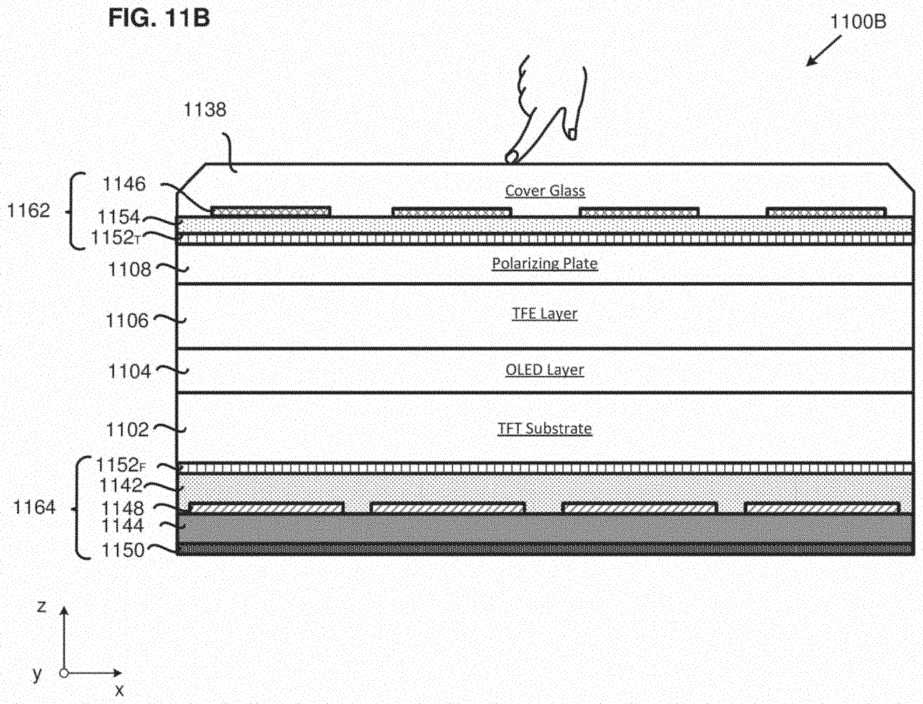

FIG. 11A is a cross-sectional view illustrating a configuration of an organic electroluminescent (EL) display panel 1100A having integrated sensor structure, according to an example implementation of the present disclosure. As illustrated in FIG. 11A, the organic EL display panel 1100A includes a thin film transistor (TFT) substrate 1102, an organic light emission layer 1104, a TFE layer 1106, a polarizing plate 1108, an integrated sensor 1140 (e.g., a touch panel), and a cover film 1138.

The integrated sensor 1140 includes at least one elastomeric layer 1142 (e.g., having a low Young's modulus elastomeric material), at least one piezo-electric layer 1144 having (e.g., having a piezo-electric material), and an insulating layer 1154. The integrated sensor 1140 also includes several layers of sensing electrodes. For example, the sensing electrode layers include at least one touch sensing electrode layer 1146, a first force sensing electrode layer 1148, a second force sensing electrode layer 1150, a touch sensor and force sensor shared transmit electrode layer 1152. Each of the touch sensing electrode layer 1146, the first force sensing electrode layer 1148, the second force sensing electrode layer 1150, the touch sensor and force sensor shared transmit electrode layer 1152 may include one or more electrodes therein.

In the present implementation, the features in the integrated sensor 1140 are substantially the same as the respective features in the integrated sensor 640 described with reference to FIG. 6A above. Thus, the details of the integrated sensor 1040 are omitted for brevity.

FIG. 11B is a cross-sectional view illustrating a configuration of another organic EL display panel 1100B having integrated sensor structure, according to an example implementation of the present disclosure. As illustrated in FIG. 11B, the organic EL display panel 1100B includes a thin film transistor (TFT) substrate 1102, an organic light emission layer 1104, a TFE layer 1106, a polarizing plate 1108, and a cover film 1138.

As illustrated in FIG. 11B, a touch sensor 1162 and a force sensor 1164 are separated, where the touch sensor 1162 is on a top side of (e.g., above) the organic light emission layer 1104, and the force sensor 1164 is on a bottom side opposite the top side (e.g., below) of the organic light emission layer 1104 and below the TFT substrate 1102.

The touch sensor 1162 includes a touch sensing electrode layer 1146, an insulating layer 1154, and a touch sensor transmit electrode 1152T, which may correspond to the touch sensing electrode layer 646, the insulating layer 654, and the touch sensor and force sensor shared transmit electrode layer 652, respectively, in FIG. 6A.

The force sensor 1164 includes a force sensor transmit electrode 1152r, an elastomeric layer 1142, a first force sensing electrode layer 1148, a piezo-electric layer 1144, and a second force sensing electrode layer 1150, which may correspond to the touch sensor and force sensor shared transmit electrode layer 652, the elastomeric layer 642, the first force sensing electrode layer 648, the piezo-electric layer 644, and the second force sensing electrode layer 650, respectively, in FIG. 6A.

In one implementation, the touch sensor transmit electrode 1152T and the force sensor transmit electrode 1152_{F} may be coupled to the same or similar excitation signal (Tx). For example, when touch and force are sensed simultaneously, the two Tx signals may be connected together to the same stimulus signal source. In another implementation, the touch sensor transmit electrode 1152T and the force sensor transmit electrode 1152_{F} may be coupled to different excitation signals, for example, when multiplexing.

In various implementations of the present disclosure, a projected capacitance sensing sensor panel is integrated in a display panel (e.g., the ones used in smartphones) to detect touch. For example, the presence of a finger near the projected capacitance sensing electrode(s) may change the capacitance in the projected capacitance sensors, which can be sensed by one or more current integrators. In the present disclosure, the term “touch” may be used to describe this kind of detection as opposed to “force” detection. Touch can include detection of actual touching on the display panel as well as a hovering finger near the projected capacitance sensing electrode(s) (even though there's no actual touching).

In various implementations of the present disclosure, a force sensing sensor panel is also integrated in the display panel to detect forces such as press and hold using piezo-electric effect. Piezo-electric effect generates transient charge when the force sensing sensor panel is squeezed. The transient charge can be detected by one or more charge integrators, similar to the sensing methodology as the touch sensors. However, charge generated by piezo-electric effect decays quickly with time because it is removed by the current integrator as part of the sensing circuit. When one presses and holds the touch panel, a burst of charges will only appear and decay at the beginning of the press and won't appear again until the touch is released. This makes piezo-electric sensing suitable for sensing a rather dynamic force or pressure. Piezo-electric sensing may be particularly advantageous to provide sufficient sensitivity to measuring light forces (e.g., tapping lightly on a keyboard) with a barely (humanly) detectable degree.

In various implementations of the present disclosure, an elastomeric sensing sensor panel is also integrated in the display panel. Capacitive force sensors work with air, elastomeric solid or compressible fluid between plates. When a force is applied, the force moves the plates closer, which causes changes in their mutual capacitance. The elastomeric sensing method is suitable for sensing static pressure/force. Elastomeric sensing may be particularly advantageous to provide sufficient sensitivity to measuring continued forces such as continuous but finely variable pressure.

In various implementations of the present disclosure, multi-touch sensing with many electrode groups is also utilized, where each electrode group provides signals relating to a region of the sensor (e.g., laid out in a grid) and provides sensitivity at that region so that one or more touches can be sensed and tracked simultaneously.

In various implementations of the present disclosure, in a self-capacitance mode, a single electrode's capacitance is measured, for example by applying an electrical waveform and measuring the flow of current to the electrode.

In various implementations of the present disclosure, in a mutual capacitance mode, capacitance is measured by injecting a signal to one electrode (usually called “Tx” for “transmit”) and measuring the resultant signal on another electrode (usually called “Rx” for “receive”). The Tx and Rx lines can be used to address one region in a grid as a pair of orthogonal coordinates. For example, a Tx selects a row and a Rx selects a column, and the resulting output relates to the signal at the intersection.

From the above description, it is manifested that various techniques may be used for implementing the concepts described in the present disclosure without departing from the scope of those concepts. Moreover, while the concepts have been described with specific reference to certain implementations, a person of ordinary skill in the art may recognize that changes may be made in form and detail without departing from the scope of those concepts. As such, the described implementations are to be considered in all respects as illustrative and not restrictive. It should also be understood that the present disclosure is not limited to the particular implementations described above, but many rearrangements, modifications, and substitutions are possible without departing from the scope of the present disclosure.

1. A touch panel comprising:
at least one capacitive touch sensing electrode, each of which extends along a predetermined direction;
at least one first force sensing electrode, each of which extends along the predetermined direction, and being opposite to the at least one capacitive touch sensing electrode in one to one relationship;
a second force sensing electrode;
an elastomeric layer between the at least one capacitive touch sensing electrode and the at least one first force sensing electrode; and
a piezo-electric layer between the least one first force sensing electrode and the second force sensing electrode.

2. The touch panel of claim 1, further comprising:
at least one shared sensing electrode between the elastomeric layer and the at least one capacitive touch sensing electrode.

3. The touch panel of claim 2, wherein:
the at least one shared sensing electrode extends along a first direction; and
the at least one capacitive touch sensing electrode extends along a second direction intersecting the first direction.

4. The touch panel of claim 2, further comprising:
an insulating layer between the at least one shared sensing electrode and the at least one capacitive touch sensing electrode.

5. The touch panel of claim 2, wherein:
the at least one shared sensing electrode is used as a shield electrode or a transmit electrode for force sensing.

6. The touch panel of claim 1, wherein:
a deformation of the elastomeric layer relates to a static force of pressing the touch panel; and
a charge generated by the piezo-electric layer is related to a dynamic force on the touch panel.

7. The touch panel of claim 1, further comprising a display stack, wherein the elastomeric layer and the piezo-electric layer are disposed on one side of the display stack.

8. (canceled)

9. The touch panel of claim 1, further comprising a display stack, wherein the elastomeric layer and the piezo-electric layer are disposed on opposite sides of the display stack.

10. (canceled)

11. The touch panel of claim 1, wherein the at least one capacitive touch sensing electrode, the at least one first force sensing electrode, and the second force sensing electrode are coupled to a sensing integrated circuit capable of sensing a projected capacitance touch, a piezo-electric force, and an elastomeric force simultaneously.

12. The touch panel of claim 2, wherein the at least one capacitive touch sensing electrode, the at least one first force sensing electrode, the second force sensing electrode, and the at least one shared sensing electrode are coupled to a sensing integrated circuit capable of sensing a projected capacitance touch, a piezo-electric force, and an elastomeric force simultaneously.

13. A touch panel comprising:
a capacitive touch sensing electrode layer having at least one capacitive touch sensing electrode, each of which extends along a predetermined direction;
a first force sensing electrode layer having at least one first force sensing electrode, each of which extends along the predetermined direction, and being opposite to the at least one capacitive touch sensing electrode in one to one relationship;
a second force sensing electrode layer having a second force sensing electrode;
an elastomeric layer between the capacitive touch sensing electrode layer and the first force sensing electrode layer;
a piezo-electric layer between the first force sensing electrode layer and the second force sensing electrode layer; and
a shared sensing electrode layer having at least one shared sensing electrode between the elastomeric layer and the capacitive touch sensing electrode layer,
wherein the at least one capacitive touch sensing electrode, the at least one first force sensing electrode, the second force sensing electrode, and the at least one shared sensing electrode are coupled to a sensing integrated circuit capable of sensing a projected capacitance touch, a piezo-electric force, and an elastomeric force simultaneously.

14. The touch panel of claim 13, wherein:
the at least one shared sensing electrode extends along a first direction; and
the at least one capacitive touch sensing electrode extends along a second direction intersecting the first direction.

15. The touch panel of claim 13, further comprising:
an insulating layer between the shared sensing electrode layer and the capacitive touch sensing electrode layer.

16. The touch panel of claim 13, wherein:
the at least one shared sensing electrode is used as a shield electrode or a transmit electrode for force sensing.

17. The touch panel of claim 13, wherein:
a deformation of the elastomeric layer relates to a static force of pressing the touch panel; and
a charge generated by the piezo-electric layer is related to a dynamic force on the touch panel.

18. The touch panel of claim 13, further comprising a display stack, wherein the elastomeric layer and the piezo-electric layer are disposed on one side of the display stack.

19. The touch panel of claim 18, wherein the display stack comprises an organic electroluminescent layer or a liquid crystal layer.

20. The touch panel of claim 13, further comprising a display stack including an organic electroluminescent layer, wherein the elastomeric layer and the piezo-electric layer are disposed on opposite sides of the display stack.

21. The touch panel of claim 1, wherein a width of each of the at least one first force sensing electrode is larger than that of corresponding one of the at least one capacitive touch sensing electrode, the width being a length in a direction perpendicular to the predetermined direction.

22. The touch panel of claim 13, wherein a width of each of the at least one first force sensing electrode is larger than that of corresponding one of the at least one capacitive touch sensing electrode, the width being a length in a direction perpendicular to the predetermined direction.
